(19) United States
(12) Patent Application Publication
(10) Pub. No.: US 2008/0218941 A1
(43) Pub. Date: Sep. 11, 2008

(54) MULTIFUNCTIONAL POWER STORAGE DEVICE

(76) Inventors: Julius Regalado, Gainesville, FL (US); Jon K. West, Gainesville, FL (US); Robert L. Burns, The Villages, FL (US); Mark Kohler, Ocala, FL (US)

Correspondence Address: LAW OFFICE OF DAVID MCEWING, P.O. BOX 231324, HOUSTON, TX, 77023, US

(21) Appl. No.: 11/936,937

(22) Filed: Nov. 8, 2007

Related U.S. Application Data
(60) Provisional application No. 60/893,564, filed on Mar. 7, 2007.

(51) Int. Cl. H01G 9/025; B01J 27/24

(52) U.S. Cl. 361/525; 427/80; 502/200

(57) ABSTRACT

A device and method for the fabrication of a power storage device or ultracapacitor manufactured from a process comprising nickel, chromium or stainless steel sintered on a metal substrate at a temperature of at least 850° C. in an inert atmosphere. The method further comprises stainless steel as the substrate. A catalyst of magnesium, manganese and iron combine with Nitric acid and de-ionized water may also be used.

### RELATED APPLICATION

This application claims priority to and benefit of provisional application No. 60893564 entitled “Multifunctional Power Storage Device” filed Mar. 7, 2007 and which is incorporated herein by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of contract No. HQ0006-05-C-7220.

### BACKGROUND OF INVENTION

1. Field of Use

The invention pertains to the method of manufacture and application of ultracapacitors, particularly ultracapacitors utilizing carbon nanotubes (“CNT”).

2. Prior Art

Methods of manufacturing some ultracapacitors are known in the prior art. For example reference is made to U.S. Pat. No. 7,095,603.

### SUMMARY OF INVENTION

Ultracapacitors are electrochemical capacitors with unusually high energy density when compared to common capacitors. One area of interest is use of the ultracapacitors for the storage of electrical power. They can be replacements or supplements to batteries.

The device and method subject of this disclosure pertains to an ultracapacitor comprising carbon nanotubes manufactured from powdered nickel or chromium sintered on a metal substrate at 900° C. in an inert atmosphere such as argon or nitrogen atmosphere. After sintering is completed, the growth of carbon nanotubes (sometimes referred to as “CNT”) is catalyzed by introducing hydrocarbon gas precursors such as methane or ethylene. The substrate may comprise of metals such as stainless steel or nickel.

The manufacturing process may achieve distributions of carbon nanotubes (multi-wall and single-wall) bonded/physically interlocked onto the metal material (Nickel or Stainless Steel or Chromium), the totality comprising the electrode and, when combined with an electrolyte of KOH and/or Glacial ascetic acid and acetate salt mixture, the combination demonstrates high specific capacitance and voltages between 1.2 to 18 volts of potential.

### SUMMARY OF DRAWINGS

FIG. 1 outlines the fabrication steps for the manufacturing of the electrode substrate and CNT of the invention.

FIG. 2 illustrates a scanning electron microscope image (SEM image) of a section of CNT enhanced electrode.

FIG. 3 illustrates an SEM image resolving CNT material bonded and interlocked with metallic substrate.

FIG. 4 illustrates an SEM image at 2,500× resolving CNT materials.

FIG. 5 illustrates an SEM image depicting high aspect ratio (length to width) of CNT materials.

FIG. 6 is an SEM image illustrating CNT materials having mean diameters less than 30 nm.

FIG. 7 illustrates a perspective view of the multilayer test cell including the middle layer insulator.

FIG. 8 illustrates a perspective view of the ultracapacitor cell showing the insulating layer between the CNT enhanced electrodes.

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

### DETAILED DESCRIPTION OF INVENTION

The above general description and the following detailed description are merely illustrative of the device and methods of this specification and additional modes, advantages and particulars of these devices and methods will be readily suggested to those skilled in the art without departing from the spirit and scope.

The specification discloses a novel method of manufacturing multi-walled carbon nanotubes (CNT). The specification also discloses a novel electrolyte that achieves unprecedented power when used in combination with ultracapacitors.

In one embodiment, the process begins with a metal foil electrode substrate of nickel or stainless steel. The electrode is coated with nickel chrome powder, stainless steel powder and a catalyst solution. In another embodiment, a stainless steel substrate is coated with stainless steel powder. The next step is chemical vapor deposition (CVD) processing at 900° C. and sintering the power for 30 minutes. Included is CNT growth processing within a temperature range of 600° C. to 1,200° C. with hydrogen and hydrocarbon gas precursors. (See Table 1) This process achieves a CNT enhanced electrode.

Numerous carbon nanotubes were tested and evaluated. Initially commercially available CNT were evaluated. However the results were not deemed satisfactory. It was determined that efforts should be made by the inventors to fabricate their own supply of CNT. Various methods and materials were tried and evaluated. Methane and/or ethylene were used as the carbon sources in combination with substrates (ceramic powders, and metal).

TABLE 1
CVD PROCESS RECIPIES

| | | | Ethylene | Methane | Hydrogen |
|---|---|---|---|---|---|
| PROCESS ID | Growth | Temp C. | (SLPM) | (SLPM) | (SPLM) |
| VT-CVD-1 | | 700 | 0.7 | | −0.7 |
| VT-CVD-2 | | 750 | 0.7 | | −0.7 |
| VT-CVD-3 | | 800 | 0.7 | | −0.7 |
| VT-CVD-4 | | 900 | 0.7 | | −2 |
| VT-CVD-5 | | 900 | 0.5 | | −2 |
| VT-CVD-6 | | 900 | 0.3 | | −2 |
| VT-CVD-7 | | 900 | | −2 | 0.4 |
| VT-CVD-8 | | 900 | | −2 | 0.2 |

Also catalytic solutions were used in the fabrication process of the sintering particles on the metal substrates.

TABLE 2
Catalyst Solution Constituents

| | | | | | | 100 mesh | | |
|---|---|---|---|---|---|---|---|---|
| CAT ID | HNO₃ | Di-H₂O | MnO₂ | MgO | Al₂O₃ | Fe | Fe(NO₃)₃ | Cu(NO₃)₂2½H₂O |
| VT-Cat-1 | X | X | | | | | | |
| VT-Cat-2 | X | X | | | | X | | |
| VT-Cat-3 | X | X | | | X | | X | |
| VT-Cat-4 | X | X | | X | | | X | |
| VT-Cat-5 | X | X | X | X | | X | X | |
| VT-Cat-6 | X | X | X | X | X | | X | |
| VT-Cat-7 | X | X | | | | | | X |

The best preparation of the catalytic solution (VT-Cat-5) is composed of the following constituents: Magnesium, manganese, and iron dissolved in an aqueous bath of Nitric Acid and de-ionized water. The mass ratios of Mg:MN:Fe:HNO₃(15.5M):H₂O is 8:2:1:20:20 respectively. The catalytic solution can be used on nickel foam substrates and further processed using chemical vapor deposition.

For the porous nickel substrate, 4 grams of catalytic solution were used per gram of nickel substrate. The same ratio was used for iron wool processing.

The specification also teaches the fabrication of CNT beginning with the sintering of nickel or chromium powder at 900° in an argon atmosphere. The substrate may be stainless steel or nickel. The process preferably utilizes stainless steel foil with stainless steel powder. The catalytic solution containing magnesium, manganese and iron is used with the metal.

The electrolyte developed by the inventors comprises a saturated mixture of anhydrous ascetic acid (fluid) and potassium acetate salt (powder). Potassium acetate salt is added to the point of saturation. The liquid is used as the electrolyte.

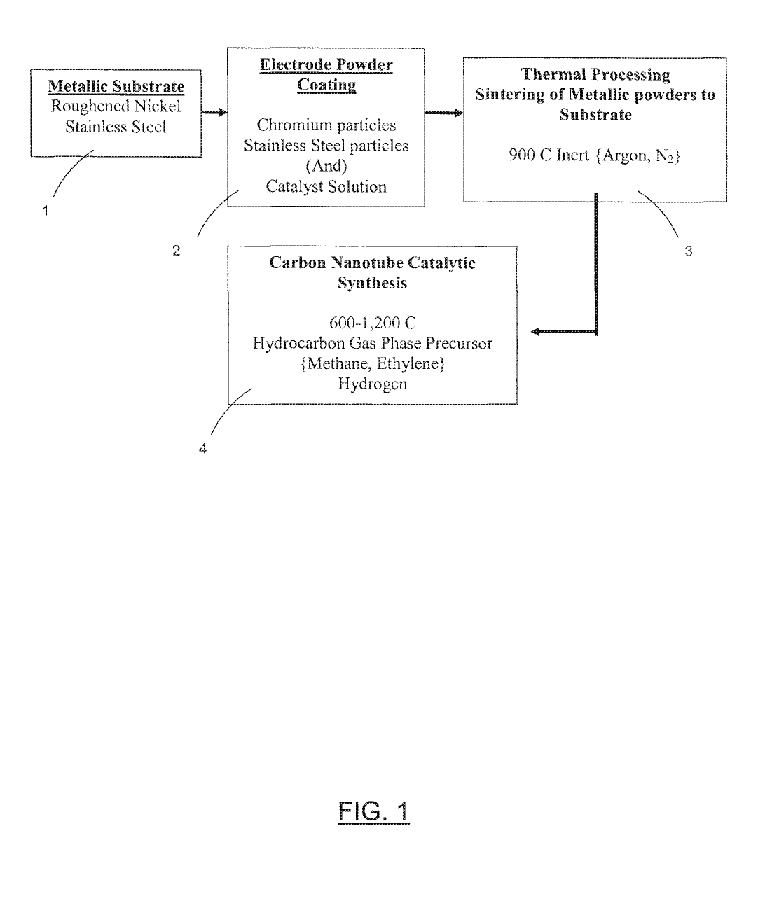

FIG. 1 illustrates the process steps of one embodiment of the invention. The first step 1 includes roughening nickel or stainless steel. The second step 2 includes coating the nickel or stainless steel with chromium or stainless steel particles and the addition of a catalyst solution. The third step 3 includes the thermal processing of the metal and metal particles to achieve sintering of the particles on the metal substrate. The process temperature is 900° C. in an inert atmosphere such as argon or nitrogen. The catalytic synthesis of carbon nanotubes 4 is performed within a temperature range between 600° C. and 1200° C. in hydrocarbon gas phase precursor (such as methane or ethylene) and hydrogen.

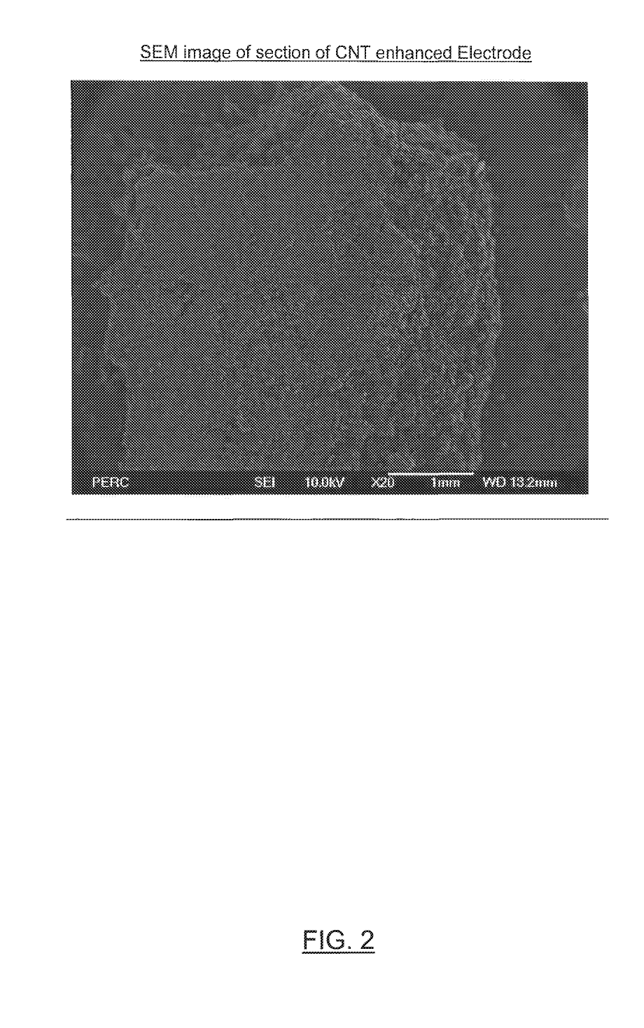

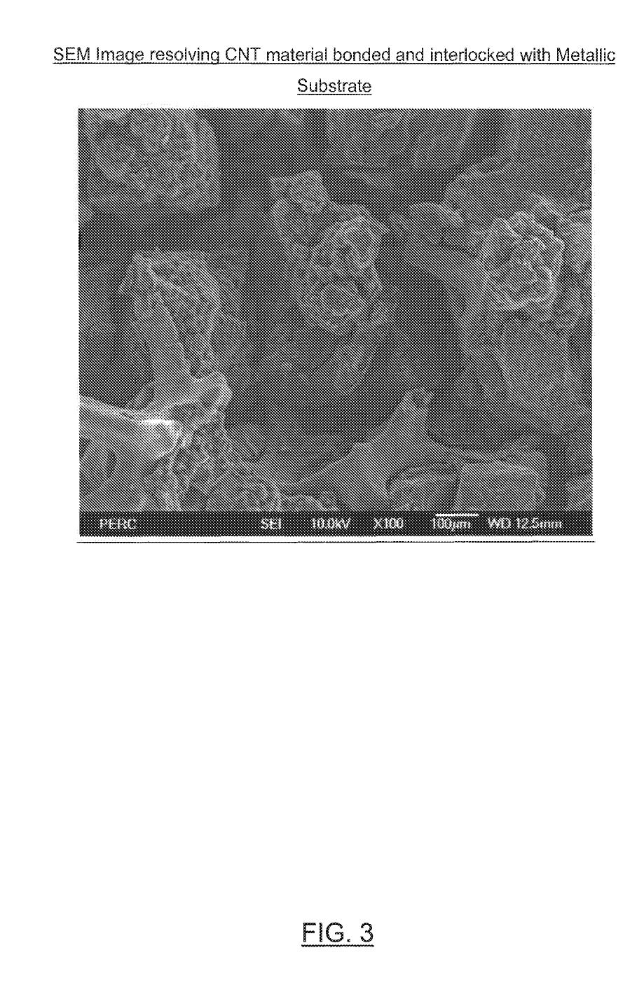

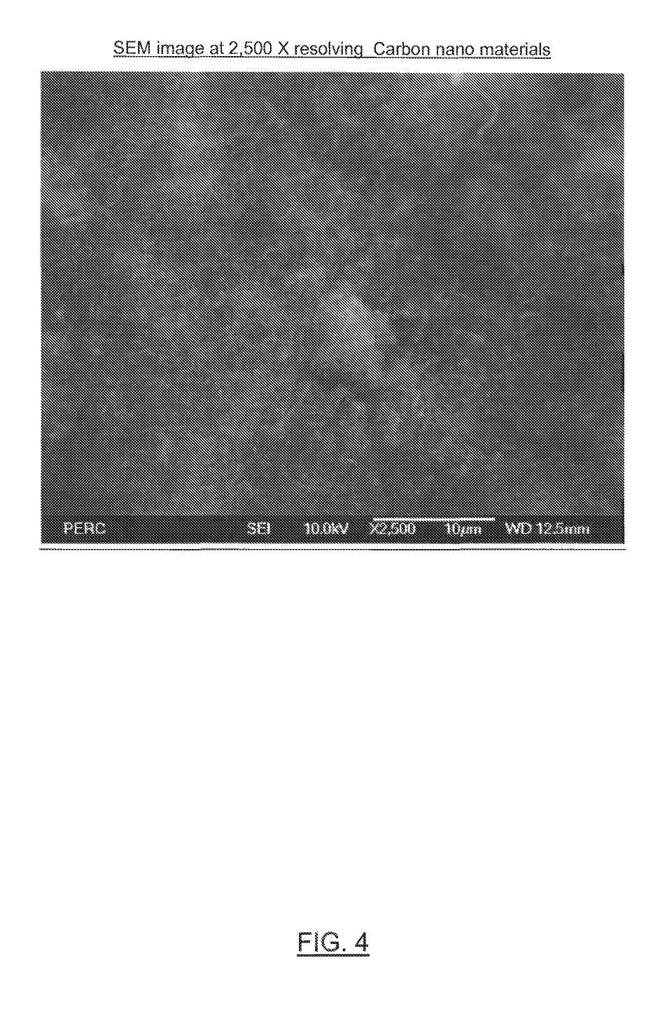

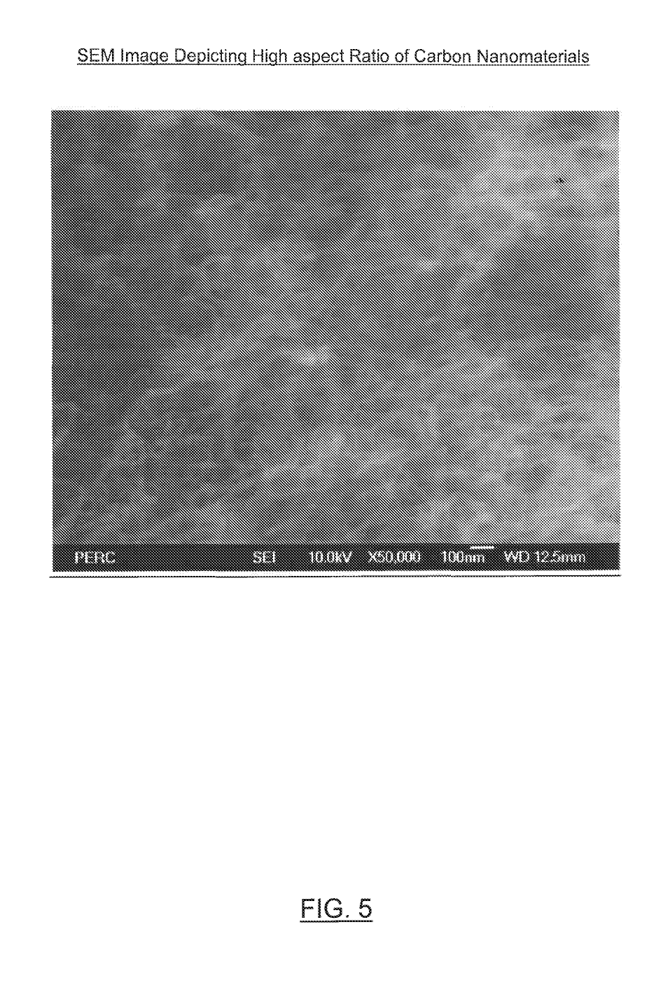

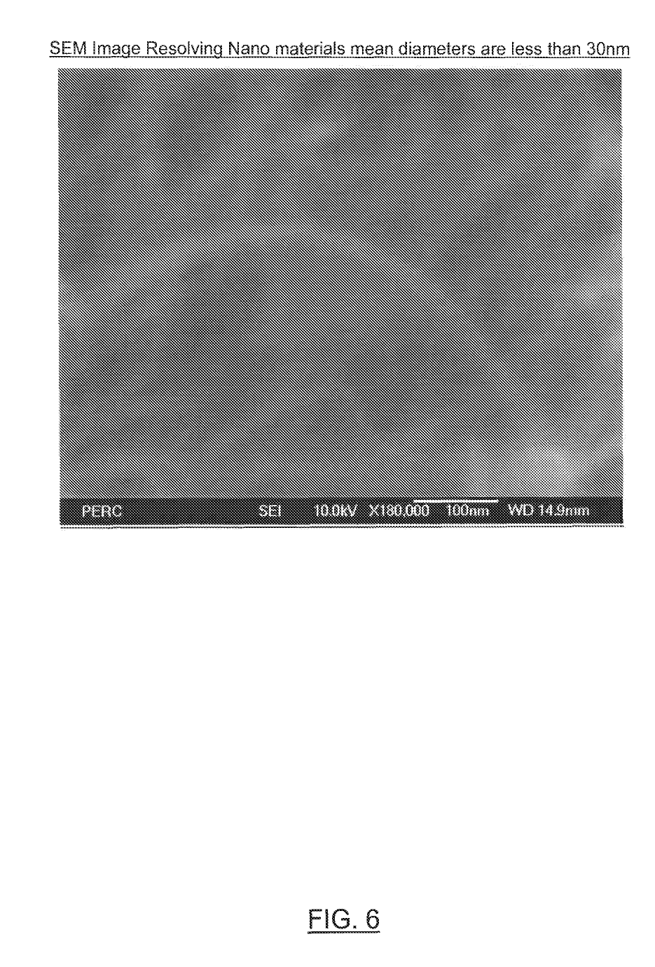

FIG. 2 illustrates an SEM image of a CNT electrode at 20 power magnification. FIG. 3 illustrates an SEM image showing the CNT material bonded and interlocked with the metallic substrate. Magnification is at 100 power. FIG. 4 shows the material at 2500 power of magnification. The fibrous nature of the CNT is discernable. FIG. 5 illustrates the CNT material at 50,000 power of magnification. The high aspect ratio of the CNT material is illustrated. FIG. 6 illustrates at 180,000 power of magnification that the mean diameter of the CNT fibers is less than 30 nanometers.

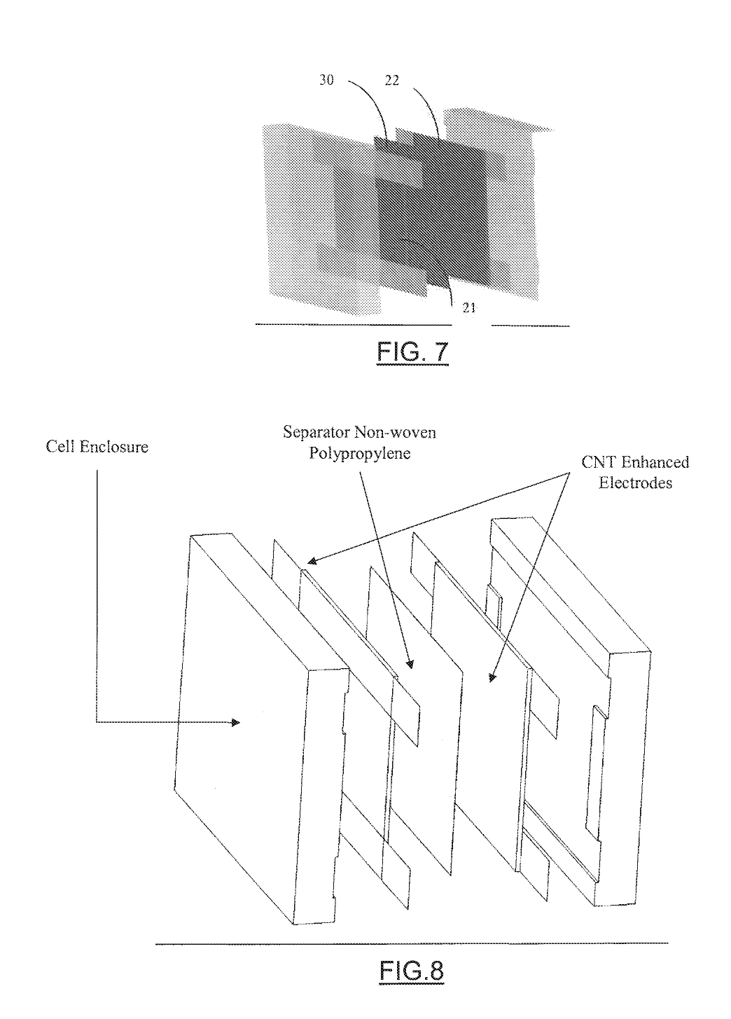

FIG. 7 illustrates the two CNT enhanced electrodes 21, 22 and the non conductive separator material 30. FIG. 8 illustrates a similar structure comprising two cell enclosures (being the outer layers of the structure), two CNT enhanced electrodes further comprising a metal substrate and sintered metal particles, and the non conductive separator layer (which can be non-woven polypropylene).

An ultracapacitor pouch cell was fabricated utilizing the CNT electrode fabricated with the sintering process and with the electrolyte of anhydrous ascetic acid and potassium acetate salt. The cell powered a motor for nearly 60 seconds. It was encased in rubber. The size of the encased cell was approximately 1½ inches long by ½ inch wide. The measured voltage was 18V. The device utilized electrodes comprising CNT on stainless steel on chromium powder.

This pouch cell demonstrated specific power (W/Kg) of approximately 15,000 and specific energy (Wh/Kg) of 20. It demonstrated 3 times the specific power of the commercially available NessCap ultracapacitor and 20 times more specific energy.

TABLE 3
Test Conditions

| | |
|---|---|
| Charge Current | 1 Amp |
| Discharge Current | 1 Amp |
| Max. Voltage | 18.2 Volts |
| Discharge MPV | 10 Volts |
| Average Discharge Power | 10 Watts |
| Discharge Capacity | 1.387 mAh |
| Cell Size | 1 sq. cm. (0.45 cc) |
| Cell Weight | 0.68 g |

This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention may be utilized independently of the use of other features, all as would be apparent to one skilled in the art after having the benefit of this description of the invention.

Further modifications and alternative embodiments of this invention will be apparent to those skilled in the art in view of this specification.

1. A power storage device manufactured from a process comprising nickel, chromium or stainless steel sintered on a metal substrate at a temperature of at least 850° C. in an inert atmosphere.

2. The method of claim 1 further comprising stainless steel as the substrate.

3. The method of claim 2 further comprising stainless steel foil.

4. The method of claim 1 further comprising Nickel foil.

5. The method of claim 1 where the inert atmosphere is argon or nitrogen.

6. The method of claim 1 further comprising a catalytic solution comprised of magnesium, manganese and iron dissolved in an aqueous bath of Nitric acid and de-ionized water.

7. The catalytic solution of claim 6 comprising magnesium, manganese, and iron dissolved in an aqueous bath of Nitric acid and de-ionized water having a mass ratio of Mg:Mn:Fe:HNO₃(15.5M):H₂O of 8:2:1:20:20.

8. The method of claim 1 further comprising growing multi-wall carbon nanotubes by introduction of methane or ethane in a temperature range of between 600° and 1200° C.

9. The method of claim 1 further comprising an electrolyte of anhydrous ascetic acid and potassium acetate in saturation.

10. An ultracapacitor comprised of carbon nanotubes manufactured from a method comprising
a) Nickel sintered on a metal substrate at 900° C. in an argon or nitrogen atmosphere;
b) adding a catalyst comprised of magnesium, manganese and iron dissolved in an aqueous bath of Nitric acid and de-ionized water having a mass ratio of Mg:Mn:Fe:HNO₃(15.5M):H₂O of 8:2:1:20:20; and
c) adding a carbon precursor of methane or ethane at a temperature range between 600° and 1200°.

11. An ultracapacitor of claim 10 further comprising the step of adding an electrolyte of anhydrous ascetic acid and potassium acetate in saturation.

12. A power storage device comprised of sintered nickel on a metal substrate and coated with carbon nanotubes and further comprised of an electrolyte of anhydrous ascetic acid and potassium acetate in saturation.
